(19) United States
(12) Patent Application Publication
(10) Pub. No.: US 2005/0015645 A1
(43) Pub. Date: Jan. 20, 2005

(54) Techniques to allocate information for processing

(76) Inventor: Anil Vasudevan, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/611,204

(22) Filed: Jun. 30, 2003

(51) Int. Cl. H02H 3/05

(52) U.S. Cl. 714/5

(57) ABSTRACT

Briefly, an offload engine system that allocates data in memory for processing.

### FIELD

The subject matter disclosed herein generally relates to techniques to allocate information for processing.

### DESCRIPTION OF RELATED ART

In the prior art, an Ethernet controller performs the steps shown in FIG. 1 with respect to frames received from a network. In step 105, typically in response to an interrupt, for a frame with a valid layer 2 header, the Ethernet controller moves such frame including payload data and accompanying layer 2, layer 3, and 4 headers to a location in a host memory referred to as memory location A. In step 110, in response to an interrupt, a local CPU loads the data and accompanying layer 3 and 4 headers from memory location A. In step 115, the CPU determines whether the layer 3 and 4 headers are valid by performing layer 3 and 4 integrity checking operations. The layer 4 header also contains information of which process is to utilize the data. If the layer 3 and 4 headers are not valid, then the accompanying data is not utilized. If the layer 3 and 4 headers associated with the data are valid, step 120 follows step 115. In step 120, if a process identified by process information of layer 4 was in a “sleep state” (i.e., waiting on data), the CPU signals the process to “wake up” (i.e., data associated with the process is available). If no process is waiting on the data, the data is stored in a temporary memory location C until the associated process explicitly asks for the data. In step 125, at a convenient time, based on various conditions such as process priority levels, the operating system schedules the process for operation. In step 130, the data is stored into a memory location B that is associated with the process scheduled in step 125. In step 135, the process may execute using the subject data in memory location B.

In a technique known as “page flipping”, data is stored in a memory location associated with its process and does not need to be moved from any intermediate storage location. However, because of the manner in which memory is accessible, there is the possibility of improperly exposing portions of memory to processing by unrelated processes, thus compromising the integrity of the technique.

Under the Remote Direct Memory Access (RDMA) technique, memory is pre-allocated solely for data storage and thus lacks the flexibility to be used for other purposes. Also, the RDMA process requires new infrastructure components such as a new protocol on top of existing transport protocols as well as new interfaces between these protocols and the RDMA process. Another drawback with RDMA in the context of a server-client communication is that the client communicates to the server the address in which data is to be stored into memory. The server, in turn, transmits to the client data with the address of such data embedded into an RDMA protocol layer. The security of the memory address of the data may be compromised during communication without additional overhead.

### BRIEF DESCRIPTION OF THE DRAWINGS

The subject matter regarded as the invention is particularly pointed out and distinctly claimed in the concluding portion of the specification. The invention, however, both as to organization and method of operation may best be understood by reference to the following detailed description when read with the accompanying drawings in which:

FIG. 1 depicts a prior art process performed by an Ethernet controller;

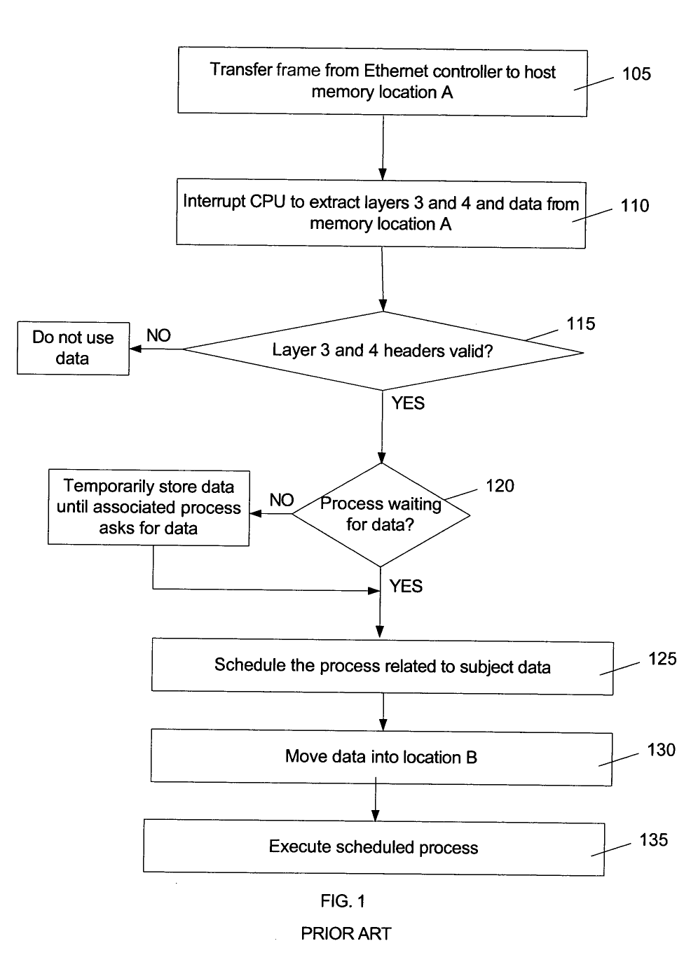

FIG. 2 depicts a system that can be used in an embodiment of the present invention;

FIG. 3 depicts a system that can be used to implement an embodiment of the present invention; and

FIGS. 4A and 4B depict flow diagrams of suitable processes that can be performed to allocate data for processing in a receiver, in accordance with an embodiment of the present invention.

Note that use of the same reference numbers in different figures indicates the same or like elements.

### DETAILED DESCRIPTION

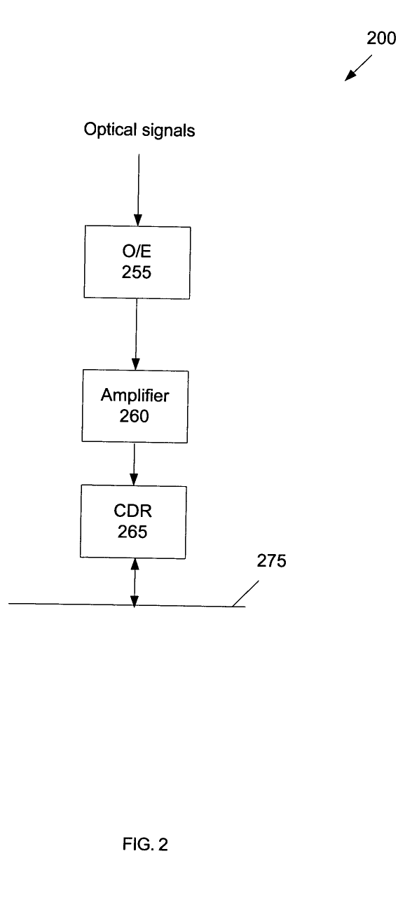

FIG. 2 depicts one possible system 200 in which some embodiments of the present invention may be used. Receiver 200 may receive signals encoded in compliance for example with optical transport network (OTN), Synchronous Optical Network (SONET), and/or Synchronous Digital Hierarchy (SDH) standards. Example optical networking standards may be described in ITU-T Recommendation G.709 Interfaces for the optical transport network (OTN) (2001); ANSI T1.105, Synchronous Optical Network (SONET) Basic Description Including Multiplex Structures, Rates, and Formats; Bellcore Generic Requirements, GR-253-CORE, Synchronous Optical Network (SONET) Transport Systems: Common Generic Criteria (A Module of TSGR, FR-440), Issue 1, December 1994; ITU Recommendation G.872, Architecture of Optical Transport Networks, 1999; ITU Recommendation G.825, “Control of Jitter and Wander within Digital Networks Based on SDH” March, 1993; ITU Recommendation G.957, “Optical Interfaces for Equipment and Systems Relating to SDH”, July, 1995; ITU Recommendation G.958, Digital Line Systems based on SDH for use on Optical Fibre Cables, November, 1994; and/or ITU-T Recommendation G.707, Network Node Interface for the Synchronous Digital Hierarchy (SDH) (1996).

Referring to FIG. 2, optical-to-electrical converter (“O/E”) 255 may convert optical signals received from an optical network from optical format to electrical format. Although reference has been made to optical signals, the receiver 200 may, in addition or alternatively, receive electrical signals from an electrical signal network or wireless or wire-line signals according to any standards. Amplifier 260 may amplify the electrical signals. Clock and data recovery unit (“CDR”) 265 may regenerate the electrical signals and corresponding clock and provide the regenerated signals and clock to interface 275. Interface 275 may provide intercommunication between CDR 265 and other devices such as a memory devices (not depicted), layer 2 processor (not depicted), packet processor (not depicted), microprocessor (not depicted) and/or a switch fabric (not depicted). Interface 275 may provide intercommunication between CDR 265 and other devices using an interface that complies with one or more of the following standards: Ten Gigabit Attachment Unit Interface (XAUI) (described in IEEE 802.3, IEEE 802.3ae, and related standards), Serial Peripheral Interface (SPI), I²C, CAN, universal serial bus (USB), IEEE 1394, Gigabit Media Independent Interface (GMII) (described in IEEE 802.3, IEEE 802.3ae, and related standards), Peripheral Component Interconnect (PCI), Ethernet (described in IEEE 802.3 and related standards), ten bit interface (TBI), and/or a vendor specific multi-source agreement (MSA) protocol.

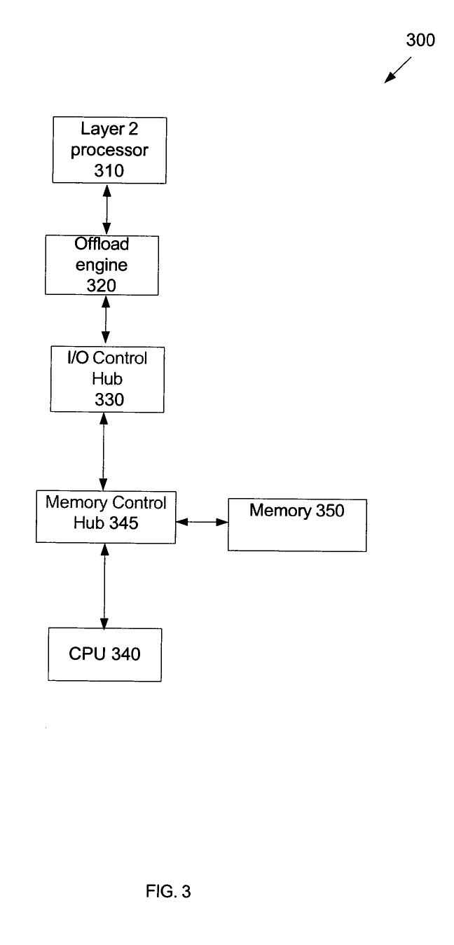

FIG. 3 depicts a system 300 that can be used in an embodiment of the present invention, although other implementations may be used. The system of FIG. 3 may include layer 2 processor 310, offload engine 320, input/output (I/O) control hub 330, central processing unit (CPU) 340, memory control hub 345, and memory 350. For example, system 300 may be used in a receiver in a communications network. System 300 may be implemented as any of or a combination of: hardwired logic, software stored by a memory device and executed by a microprocessor, firmware, an application specific integrated circuit (ASIC), and/or a field programmable gate array (FPGA).

Layer 2 processor 310 may perform media access control (MAC) management in compliance for example with Ethernet, described for example in versions of IEEE 802.3; optical transport network (OTN) de-framing and de-wrapping in compliance for example with ITU-T G.709; forward error correction (FEC) processing, in accordance with ITU-T G.975; and/or other layer 2 processing. In one embodiment, if a layer 2 header (e.g., MAC) in a received packet/frame is not valid, layer 2 processor 310 may not transfer the packet/frame to the offload engine 320. If the layer 2 header is valid, layer 2 processor 310 may transfer the unprocessed portion of the packet/frame to offload engine 320. The unprocessed portion of the packet/frame may include network control (layer 3) and transport (layer 4) layers as well as accompanying data.

Offload engine 320 may receive network control layer (layer 3), transport layer (layer 4), and accompanying data portions of a packet/frame from layer 2 processor 310. Offload engine 320 may validate the network control (e.g., IP) and transport (e.g., TCP) layers. If the network control and transport layers are valid, offload engine 320 may transfer the associated data to I/O control hub 330 for storage in a memory location in memory 350 specified by the CPU 340. The memory control hub 345 controls access to memory 350. The memory location for the data may be associated with a process or application that is to process the data. The memory location that is to store the data may be flexibly allocated for other uses before and after storage of the data as opposed to being dedicated solely to store data.

Offload engine 320 may perform other transport layer processing operations such as acknowledging receipt of the packet/frame to the transmitter of the packet/frame. Offload engine 320 may be implemented using a TCP/IP offload engine (TOE).

I/O control hub 330 may transfer data from offload engine 320 to memory 350, through the memory control hub 345 for storage in assigned locations. I/O control hub 330 may transfer commands and information between offload engine 320 and CPU 340 (through memory control hub 345). For example, to provide communication between offload engine 320 and I/O control hub 330, PCI and/or PCI express interfaces may be used, although other standards may be used. In some implementations, a direct high-speed interface between offload engine 320 and memory control hub 345 may be utilized (e.g., Communication Streaming Architecture (CSA)) to transfer data to memory 350.

In accordance with an embodiment of the present invention, CPU 340 may control storage of data into specified locations within memory and execution of processes that use data stored in memory. For example, in response to receiving an indication valid data is available as well as an identification of a process associated with the data, CPU 340 may schedule the process and allocate a storage location in memory 350 for the valid data. The CPU 340 may communicate the storage location for the data to offload engine 320 so that the offload engine 320 may store the data into memory 350. In one embodiment, unlike RDMA, the CPU does not communicate the target location for the data to the transmitter of the packet/frame which encapsulates the data.

Memory 350 may store data provided by offload engine 320 in storage locations allocated and specified by CPU 340. Allocations of storage locations for data may be flexibly modified by CPU 340 so that dedicated data-only or data-for-specific-process storage areas in memory 350 are not necessary. Memory 350 can be implemented as a random access memory (RAM). Memory control hub 345 may control access to memory 350 from different sources e.g. from CPU 340 or I/O control hub 330.

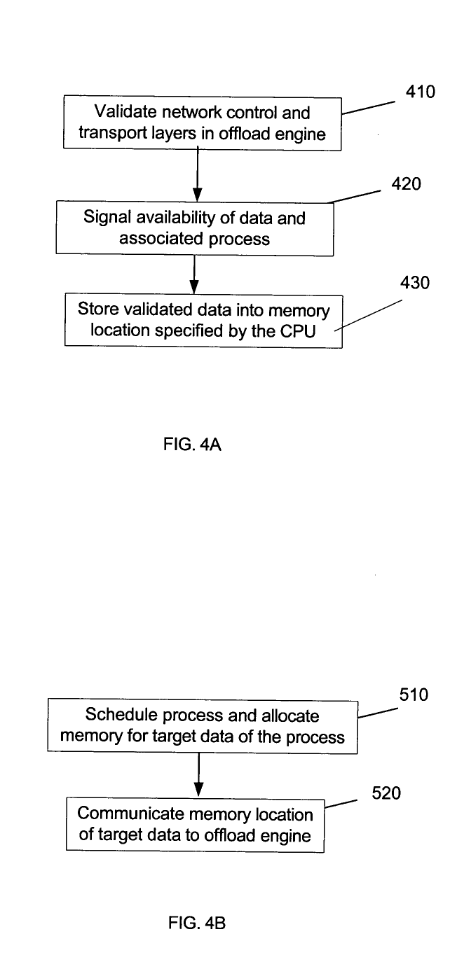

In accordance with an embodiment of the present invention, FIG. 4A depicts a flow diagram of a suitable process that can be performed by an offload engine to process frames/packets and store data provided in the frames/packets. In accordance with an embodiment of the present invention, FIG. 4B depicts a flow diagram of a suitable process that can be performed by a CPU to allocate memory locations to store data provided in the frames/packets and schedule processes that utilize the data. The processes of FIGS. 4A and 4B may interrelate so that actions of the process of FIG. 4A may depend on actions of the process of FIG. 4B and vice versa.

In action 410 of the process of FIG. 4A, an offload engine attempts to validate network layer (e.g., IP) and transport layer (e.g., TCP) information associated with data. In action 420, for data having validated associated network and transport layers, the offload engine signals to the CPU the availability of data and the related process or application that is to utilize the data from information directly or indirectly embedded in the protocol. For example, a process or application may include a web browser or electronic mail access software.

In action 430, in response to the CPU providing a target address associated with the destination process in memory to store the data, the offload engine may provide the data for storage in the target address in memory. For example, the target address may be made available as described with respect to action 520 of FIG. 4B. Thereafter, the process or application that is to utilize the data may access the data from the target address in memory.

In action 510 of FIG. 4B, in response to receiving an indication that valid data is available as well as an identification of a process associated with the data, the CPU may schedule when the process is to execute and allocate a target storage location in memory for the valid data. As described in action 420 above, the CPU may receive the indication and process identification from an offload engine that validates network layer (e.g., IP) and transport layer (e.g., TCP) information associated with data. Allocations in memory for data may be flexibly modified by the CPU so that dedicated data-only or data-for-specific-process storage areas in memory 350 are not necessary.

In action 520, the CPU may communicate to an offload engine the storage location in memory for the data so that the offload engine may store the data into the proper target location in memory. In one embodiment, unlike RDMA, the CPU does not communicate the target location for the data to the transmitter of the packet/frame that encapsulates the data.

Modifications

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

1. An apparatus comprising:
an offload engine to identify a process associated with data;
a processor to selectively determine a location to store the data in response to the process identification; and
a memory to store the data in the location, wherein the memory is configurable to store data in any storage location among the memory.

2. The apparatus of claim 1, wherein the offload engine is to provide the process identification based on header information associated with the data.

3. The apparatus of claim 2, wherein the header information comprises network layer and transport layer information.

4. The apparatus of claim 1, wherein the offload engine is to selectively transfer data for storage to the location in response to identification of the location.

5. The apparatus of claim 1, wherein the processor selectively schedules a process in response to the process identification.

6. The apparatus of claim 5, wherein the processor selectively executes the scheduled process in response to the storage of the data in the location.

7. The apparatus of claim 1, further comprising an input/output control hub to selectively transfer the data from the offload engine for storage into the memory.

8. The apparatus of claim 1, further comprising a layer 2 processor device to receive a packet and verify a layer 2 portion of the packet and to selectively provide layer 3, layer 4, and accompanying data portions of the packet to the offload engine in response to valid layer 2 of the packet.

9 A method comprising:
selectively identifying a process associated with data;
selectively determining a location to store the data in response to the process identification;
selectively allocating a memory location for the data, wherein the memory is configurable to store data in any storage location among the memory; and
selectively storing data into the storage location.

10. The method of claim 9, further comprising providing the process identification based on header information associated with the data.

11. The method of claim 10, wherein the header information comprises transport layer information.

12. The method of claim 9, further comprising selectively transferring data for storage in the location in response to identification of the location.

13. The method of claim 9, further comprising selectively scheduling the process in response to the process identification.

14. The method of claim 13, further comprising selectively executing the scheduled process in response to the storage of the data in the location.

15. The method of claim 9, further comprising:
validating network control and transport layers associated with the data; and
selectively transferring the data in response to validated control and transport layers.

16. A system comprising:
an interface device;
a layer 2 processor device to perform layer 2 processing operations on a packet received from the interface device;
an offload engine to identify a process associated with data, wherein the layer 2 processor device is to selectively provide layer 3, layer 4, and accompanying data portions of the packet to the offload engine in response to valid layer 2 of the packet;
a processor to selectively determine a location to store the data in response to the process identification; and
a memory to store the data in the location, wherein the memory is configurable to store data in any storage location among the memory.

17. The system of claim 16, wherein the interface device is compatible with XAUI.

18. The system of claim 16, wherein the interface device is compatible with IEEE 1394.

19. The system of claim 16, wherein the interface device is compatible with PCI.

20. The system of claim 16, wherein the layer 2 processor is to perform media access control in compliance with IEEE 802.3.

21. The system of claim 16, wherein the layer 2 processor is to perform optical transport network de-framing in compliance with ITU-T G.709.

22. The system of claim 16, wherein the layer 2 processor is to perform forward error correction processing in compliance with ITU-T G.975.

23. The system of claim 16, further comprising a switch fabric coupled to the interface device.
